(19) United States
(12) Patent Application Publication
(10) Pub. No.: US 2001/0039614 A1
(43) Pub. Date: Nov. 8, 2001

(54) Authorization system for license certificate management

(75) Inventors: Per Hellberg, New York, NY (US); Robert Barritz, New York, NY (US); Peter Kassan, New York, NY (US)

Correspondence Address: OSTROLENK FABER GERB & SOFFEN, 1180 AVENUE OF THE AMERICAS, NEW YORK, NY, 100368403

(73) Assignee: Isogon Corporation

(21) Appl. No.: 09/851,218

(22) Filed: May 8, 2001

Related U.S. Application Data
(60) Provisional application No. 60/203,236, filed on May 8, 2000.

(51) Int. Cl. H04L 9/00; G06F 17/60

(52) U.S. Cl. 713/156; 705/59

(57) ABSTRACT

A system that enables the creation and/or modification of license certificates for software products and simultaneously limits the ability of system programmers who operate license creation or modification tools from inadvertently or deliberately creating or modifying license certificates indiscriminately. An authorization tool, to which access is granted to only a selected number of individuals, establishes or sets criteria that defines the conditions subject to which license certificates can be created or modified, to serve the evolving and changing needs of a large number of software product users. An authorization enforcer tool monitors the license rights being created or modified and assures that the license rights and usage thereof are in compliance with the criteria set by the authorization tool.

### RELATED APPLICATION

This Application claims priority and is entitled to the filing date of U.S. Provisional Application Ser. No. 60/203,236 filed May 8, 2000, and entitled “AUTHORIZATION SYSTEM FOR LICENSE CERTIFICATE MANAGEMENT”, the contents of which are incorporated by reference herein.

### BACKGROUND OF THE INVENTION

The present invention relates to computer software and more particularly to a computer software, license compliance verification and control system.

When computer software products are licensed to user organizations, the price charged is generally based on the licensed rights conferred. Those rights might be couched in terms of how many computers the product may be executed on, or the aggregate processing power of the computers on which the product will execute, or the particular identities of the computers, or the total number of individuals who may use the product at any given time, or the particular set of named users who may use the product, and so forth.

An organization with ten computers might license the identical software product, and receive the very same physical media containing the product, as an organization with a single computer, but might pay six or eight times as much. This is considered appropriate, since the larger organization will be deriving more use and value from the software product, and is therefore willing to pay a higher license fee. And if, after initially licensing the software for an initial number of computers (or aggregate power, or number of individuals, etc.), the organization wishes to operate the product on a greater number of computers (or aggregate power, or number of individuals, etc.), the software vendor will want to charge an “upgrade” fee to grant those additional licensed rights.

It is therefore very important to vendors to try to ensure that licensees of their products do not use them beyond the rights that the licensees have paid for.

Many vendors control the use of their licensed software products via some type of Execution Control Mechanism (ECM). This might take the form of a License Manager (LM), such as FLEX1m from Globetrotter, LicensePower/iFOR from Isogon, Sentinel/LM from Rainbow, and an upcoming XSLM-compliant LM from IBM.

Alternatively, a software vendor might develop his own ECM, specifically for use only with that vendor's licensed products. Licensees of a software product controlled by a particular ECM are obliged to install and operate that ECM on the licensee's computer system or network. (Many vendor-specific ECMs are embedded in the licensed products they control, and do not have to be executed separately.) The ECM accepts passwords or license certificates, supplied by the vendor of the licensed software, that describe the extent of the licensed rights, such as the computers the software may run on (as defined by their serial numbers), the number of concurrent users, the identity of particular authorized users, etc.

Typically, when a licensed software product begins its execution, it invokes the ECM, perhaps using an Application Programming Interface (API) defined for this purpose by the vendor of the LM, and supplying identification information consisting of the name of the software product. The ECM determines if there exists a license certificate corresponding to the software product in question, and, if so, whether the licensed rights detailed in the certificate match the circumstances of use. If they do, a “clear-to-proceed” response is returned to the licensed software product. But if they do not—if, for example, the licensed software product is currently executing on a computer whose serial number is not defined in the certificate—the ECM returns an “out-of-compliance” response to the licensed software product, which can take whatever action is deemed appropriate under that circumstance.

Software vendors who instrument their products to use the services of an ECM can elect to have those products, if they should receive an “out-of-compliance” response from the ECM, simply refuse to process further, terminating, perhaps with an explanatory message. (This is known as a “hard stop”.) In this way, vendors are fully protected against misuse of their products.

However, end-user licensees generally regard hard-stops as extremely harsh and unyielding, possibly even constituting unlawful repossession of the software. They take the view that there may be a valid justification for going beyond the rights conferred by the software license. For example if a computer fails, and has to be replaced by another on an emergency basis, any licensed software products whose license is tied to the computer serial number of the original computer will receive an out-of-compliance signal from the ECM if the user attempts to operate them on the replacement computer. As another example, if a particular employee, to whom a software product is tied by name, is replaced (perhaps, due to illness, only by a temporary worker), the new employee will not be able to use the software product, and therefore may not be able to perform his job duties.

User organizations are typically permitted by their license agreements to replace a computer or an employee with another. But until they formally notify the software vendor of the change, and receive a new license certificate reflecting that change, the ECM will continue interpreting the situation as out-of-compliance, causing (from the user's perspective) inappropriate hard-stops.

Acknowledging these concerns, some vendors do not use hard-stops in their products, relying instead on the strength of the provisions in their license agreements, and the hope that user organizations will not wish to violate the terms of a contract. Vendors may also, in their license agreements, require the right to periodically audit the activities of the licensee to ensure that license terms have been complied with. And some vendors, while continuing to use the services of an ECM for their products, do not employ a hard-stop in out-of-compliance instances, instead allowing the products to continue to operate after issuing a warning or alert that an out-of-compliance situation exists.

Other vendors might employ hard-stops in their products for some or all out-of-compliance conditions but allow users to freely create certificates (using a License Creation Tool, LCT) or modify certificates (using a License Administration Tool, LAT). Note that in general, certificates can't be physically modified, once created, so the term “modified” should be read to mean “augmented” or “amended”. This approach, called “customer managed licensing”, gives users the unilateral ability to define certificates embodying additional rights, perhaps any rights they choose, whether or not those rights are actually contained in the applicable license agreement (sometimes a license certificate may limit the scope within which the customer may make modifications). Thus, the user can often avoid the occurrence of a hard-stop by defining an appropriate certificate or making the appropriate modification to a certificate, even going beyond the conditions of their license if they feel this is proper or necessary. And users may also be permitted to create or modify certificates when they wish to extend their licensed rights in a way that might incur additional charges from the vendor.

But the ability for users to freely create or modify certificates is a double-edged sword. While giving the users the freedom and flexibility that they desire, and eliminating the necessity to contact the vendor for a new or revised certificate, this ability carries with it the danger that the user may revise a certificate in such a way as to inadvertently incur future charges when the vendor, in due course, becomes aware of the change. This might also occur if the technical or administrative employee making the revision to the certificate has not obtained the appropriate authorization within the user-organization itself. The individuals creating or modifying certificates, typically technical or administrative staff, are often not the individuals, typically purchasing, contracts, or asset management department staff, with whom the authority to approve such changes is vested. This represents a management problem and exposure.

### SUMMARY OF THE INVENTION

Accordingly, it is an object of the present invention to provide an ability to freely create or modify license certificates in a manner that prevents inadvertent or unrestricted license certificate creation or modification.

It is another object of the invention to provide the ability to create or modify license certificates without unduly altering existing license management software.

It is a still further object of the invention to provide a limited ability for authorized personnel to create or modify license certificates in a fashion that protects vendors of licensed software.

The foregoing and other objects of the invention are realized by the a system that ensures that all such license certificate changes, while continuing to be effected by system administration personnel, are always made subject to the prior approval of the appropriate authority within the organization. The invention is a license certificate management system that incorporates an authorization tool accessible only to authorized individuals, to approve proposed creations and modifications of one or more license certificates, and used in conjunction with a license manager such as one conforming to the XSLM-LM industry standard such as IBM's ILM. Authorization information is optionally stored in a controlled product table and the system optionally being configured so that in the absence of particular authorizations or permissions appearing in the table, additions or modifications to license certificates are not permitted.

In accordance with a preferred embodiment, the actual creation or modification of certificates is carried out by a license creation tool operating with or in conjunction with a license administration tool which, in turn, can be a standalone package or configured as a component part of the standard license manager software on the computer system. A Granted Authorization Table (GAT) preferably contains the actual control information for particular software, providing details surrounding each license certificate, such as whether it has been approved, modified, rescinded or otherwise changed.

Other features and advantages of the present invention will become apparent from the following description of the invention which refers to the accompanying drawings.

### BRIEF DESCRIPTION OF THE DRAWING

FIG. 1 is a flowchart illustrating main steps of a license change request procedure.

### DETAILED DESCRIPTION OF THE INVENTION

License Managers that conform to the XSLM standard (XSLM-LMs), a branded standard for License Management Systems created and published by the Open Group, permit software manufacturers to grant customers the right to freely create or modify certificates as described above. It is the object of the present invention to provide a system for organizations to ensure that all such changes, while continuing to be effected by system administration personnel, are always made subject to the prior approval of the appropriate authority within the organization. This system is known as the Authorization System for License Certificate Management (ASLCM), and comprises the following components:

1. Authorization Tool (AT): The AT is an interactive computer process that is used by those individuals with the authority (as designated by the customer) to approve the proposed creation or modification of one or more license certificates for use in an XSLM-LM system. The AT allows such authorized users to specify in detail the approved bounds and limits of any certificate creation or modification.

Optionally, in addition to the details of the approved change itself, the authorized individual may also specify the name or user-id of one or more individuals that are authorized to make the change. As another option, the authorized individual may specify an expiration date and/or beginning date, beyond which a particular authorization is to be considered void.

For example, there may be an existing certificate that applies to the Spiffy product from Isogon Corporation, specifying that the product may be used on any number of computers or computer-partitions so long as the aggregate measure of computing power of all computers and computer-partitions on which Spiffy is concurrently operating never exceeds 800 MIPS (Million Instructions Per Second). If it should be desired to raise that limit to 900 MIPS, and if this change is approved by the authorized individual, he uses the AT to specify both his approval of that change and approval of the new limit.

Note that the AT does not perform the actual creation or modification of the certificate—this is done by the technical person using the LCT or LAT. Rather the authorized individual has registered his approval of such a modification when, or if, it is performed.

The AT optionally provides the authorized individual with the ability to specify the particular products (or set of products, or products of certain vendors, or products to be used on particular specified computers, etc.) which require authorization before an associated certificate may be created or modified. These specifications are kept in a repository, the Controlled Product Table (CPT). In the absence of any such specification, the default might be that authorization is required for all certificate additions or modifications. Alternatively, the default might be that no authorization is required.

The AT keeps a record in the Granted Authorization Table (GAT) of the details surrounding each license certificate update that has been approved, modified, rescinded or otherwise changed. Each record in the GAT incorporates the authorized bounds and limits of such creation or modification for each product (or set of products, or products of certain vendors, or products to be used on particular specified computers) for which such authorization has been supplied through the AT.

2. Authorization Enforcer (AE): The AE is installed within, and becomes part of, the XSLM-LM in such a way that the AE receives control any time a new certificate is added or an existing certificate is modified. This may be achieved by a variety of methods known to those skilled in the art, such as: enhancing the XSLM-LM itself to incorporate these capabilities; establishing the AE as an exit of the XSLM-LM; by intercepting some internal XSLM-LM function and inserting the AE processing; “wrapping” one or more modules of the XSLM-LM with additional code; renaming one of the modules of the XSLM-LM and providing another module with the same name (which calls the original module as appropriate); providing another module with the same name (without renaming the original module) with instructions for the user to install it in a library of higher precedence than the library in which the original XSLM-LM module is installed.

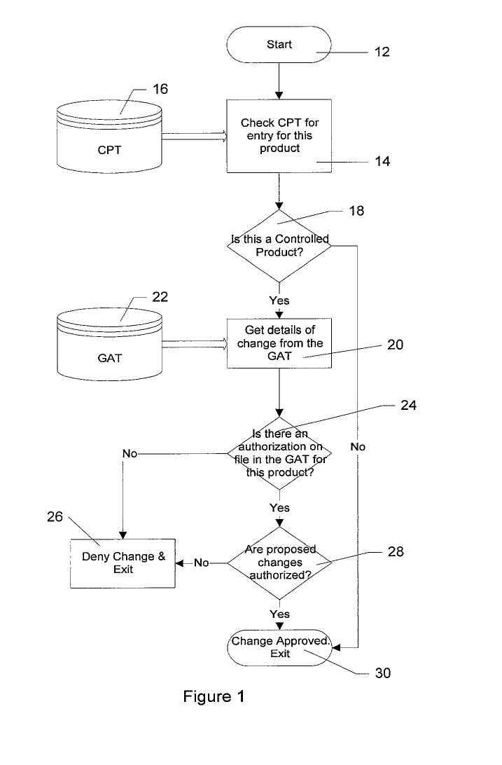

The processing of license change requests is illustrated in FIG. 1. Initialization and housekeeping chores are carried out at step 12. Thereafter, as indicated at steps 14 and 18, whenever the AE receives control, it first looks for a record corresponding to the current license certificate in the CPT 16 to determine if authorization is required. If authorization is not required, the AE terminates, returning control to the XSLM-LM via step 30, thus allowing the certificate creation or modification to proceed.

If authorization is required, or if there is no CPT and the system default is to control all products, the AE looks, as indicated by step 20, for a corresponding record in the GAT 22 to determine whether appropriate authorization has in fact been supplied. This entails finding an authorization in the GAT that applies to the current product, then inspecting the details of the certificate being created, or the types of modifications being attempted, to ensure that they conform to authorized limits and, optionally, whether the user-id making the change has been approved to do so. If authorization exists, the AE terminates by proceeding via steps 24 and 26, allowing the XSLM-LM to proceed normally. But if no authorization has been supplied in the GAT, or if the attempted certificate creation or modification extends beyond the limits of the supplied authorization, or if it conforms to those limits but the user-id has not been approved, or if a specified time limit has elapsed, the AE causes the current creation or modification operation to be denied by signaling the XSLM-LM, calling a pre-defined error routine in the XSLM-LM, exiting to a pre-defined exit routine, or other mechanism as appropriate such as aborting the calling process, as indicated by step 26.

Optionally, if a pre-specified number of creation or modification attempts have been made by a particular user-id, all of which have been denied by the AE as being unauthorized, the AE will thereafter deny all creation or modification requests made by that user-id (whether or not they would otherwise be approved) until reset by the authorized individual, using the AT, to do otherwise.

The AE logs all creation or modification attempts that the AE has denied as being unapproved, including information as to the nature of the attempt, the user-id, the reason for the abort, etc.

As an alternative to incorporating the AE within the XSLM-LM itself, the AE can be implemented as an extension to the facilities of LCT and LAT, either inherently, or as an exit, wrapper, or post-processor. It performs substantially the same processing as described above except that to deny an attempted certificate creation or modification, the AE takes the appropriate steps to prevent the LCT or LAT from supplying the resultant certificate to the XSLM-LM.

An alternative to the pre-authorization of certificate changes by the authorized individual is provided. In this embodiment, the authorized individual must approve the attempted certificate change before the AE actually allows the change to take effect. Whenever an attempt to change a license certificate is made by use of the XSLM-LM, LCT or LAT; and an approval is not already on file in the GAT, the AE notifies the authorized individual requesting an approval or denial. (Communication can be by email or other electronic notification; authorization can be via a function in the AT, via an authenticated [i.e., digitally signed] reply to the notification, or via a separate approval facility.) A variation of this embodiment allows the issuance of the attempted changes with a grace period; if a grace period was in effect, and applicable to the certificate in question, the AE allows an attempted change, even if not authorized, but if the authorization was not received by the expiration of the grace period, the AE would delete, reverse, or otherwise revoke the changed certificate. The authorized individual could, via the AT, set the rules for grace periods system wide or by individual, vendor, product, system, etc.

3. Authorization Reporter (AR): The AR uses the log produced by the AE to report on activity, which may be viewed by one or more user-specified controls such as

product,

vendor,

date or period of time,

user-id,

authorized individual,

location,

denials or approved changes to certificates,

approvals on file in the GAT

In addition to the above embodiment of the invention as applied to an XSLM-LM, note that the invention also applies more generally to other LMs, even those that do not conform to the XSLM standard.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. An authorization system for license certificate management, the authorization system comprising:
a plurality of license certificates corresponding to a plurality of software products which require corresponding ones of the license certificates to enable operation thereof;
a license certificate creation or modification tool operable to create or modify license certificates;
an authorization tool that sets criteria for the creation or modification of license certificates;
a first list of personnel authorized to use the authorization tool;
a granted authorization table (GAT) created by the authorization tool which identifies the criteria; and
a controller that enforces compliance in the creation of new or modified license certificates with the criteria in the granted authorization table.

2. The system of claim 1, including a second list specifying individuals having access to the license certificate creation or modification tool and the first list is different from the second list.

3. The system of claim 1, in which the criteria includes identities of software users.

4. The system of claim 2, in which the individuals in the second list are system programmers.

5. The system of claim 4, including a license manager, and the license creation tool is a component of the license manager.

6. The system of claim 5, further including a license administration tool which is a component part of the license manager and which effectuates the modification of certificates.

7. The system of claim 1, further including a controlled product table which identifies products or classes of licensed software requiring authorization in order to create or modify license certificates thereof.

8. The system of claim 1, in which the controller is configured as an authorization enforcer tool that receives control when a new certificate is added or an existing license certificate is modified.

9. The system of claim 8, in which the authorization enforcer is a constituent part of a license manager.

10. The system of claim 9, in which the authorization enforcer is configured as an exit routine of the license manager.

11. The system of claim 9, in which the authorization enforcer is configured as an internal intercept of the license manager.

12. The system of claim 9, in which the authorization enforcer is configured as a renamed module of the license manager.

13. The system of claim 1, in which the controller includes a tool that denies rights to a given user-id to create or modify license certificates, after the given user-id has attempted a pre-specified number of unauthorized modifications.

14. The system of claim 1, including a notification tool that notifies a pre-specified individual that changes to license certificates have been made.

15. The system of claim 1, further including a reporter tool that reports on license certificate changes authorized by the authorization tool.

16. The system of claim 15, in which the reporter creates a report which contains information presented as a plurality of datafields, including at least four of the following parameters: products; vendors; date or period of time; user-id; authorized individuals; location; denials or approved changes to certificates; and approval on file in the GAT.

17. The system of claim 7, in which the classes comprise one or more of: software product type; sets of products; products identified by vendors; and products usable on specified computers.

18. The system of claim 1, wherein the authorization tool is manually operated by an individual included in the first list in response to specific requests for license certificate creation or modification requests.
